(19) United States
(12) Patent Application Publication
(10) Pub. No.: US 2003/0085179 A1
(43) Pub. Date: May 8, 2003

(54) Methods and systems for reducing waste and emissions from industrial processes

(75) Inventors: Bang Mo Kim, Schenectady, NY (US); Stephen Lan-Sun Hung, Waterford, NY (US); Joseph James Salvo, Schenectady, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Schenectady, NY (US)

(21) Appl. No.: 09/682,995

(22) Filed: Nov. 6, 2001

(51) Int. Cl. C02F 1/68

(52) U.S. Cl. 210/739; 700/121; 705/7; 210/749; 700/266; 700/273

(57) ABSTRACT

Methods and systems are disclosed for reducing wastes produced from an industrial process. One embodiment describes communicating with a communications network and acquiring process information concerning the industrial process. A process parameter, associated with a predicted waste output, is predicted according to a predetermined model and based on the process information. The process parameter is then communicated over the communications network.

### BACKGROUND OF INVENTION

This invention generally relates to waste management and, more particularly, to methods and to systems for reducing wastes produced from an industrial process.

The United States Congress requires the monitoring and the reporting of wastes released into the environment. See Emergency Planning and Community Right-to-Know Act §304, 42 U.S.C.A. §11023 (West 1995 & Supp. 2000). Industrial manufacturers must report releases of more than six hundred (600) designated toxic chemicals to the environment. See id. at §11023(g). These reports, called Toxic Release Inventory reports, are then submitted to the United States Environmental Protection Agency and to state governments. See id. at §11023 (a). These reports are also compiled into a publicly-accessible toxic chemical database. See id. at §11023(h). This database, known as the Toxics Release Inventory, contains information concerning waste management activities and the release of toxic chemicals by facilities that manufacture, process, or otherwise use toxic materials. Citizens, businesses, and governments may then use this information to protect the quality of the land, air, and water.

Monitoring and reporting these wastes, however, can be a slow, cumbersome, and expensive task. Waste stream monitoring equipment is expensive and requires specialized training and knowledge to operate. This waste stream monitoring equipment also has high installation costs and high maintenance costs. There are also high lead times and high labor costs in gathering waste data and in presenting the waste data in the format required by the United States Environmental Protection Agency. Once this waste data is gathered and reported, added expenses are incurred to archive thousands of pages of waste documents and of regulatory submissions.

Even though the waste data is collected and reported, the waste data may not be quickly analyzed to reduce the production of wastes. Because human operators must often slowly and laboriously gather this waste data, days or weeks may pass before the data is analyzed. If the data shows excessive waste production, days or weeks of production have already passed. The manufacturer has missed an opportunity to quickly and efficiently tailor the manufacturing processing to reduce the production of waste. The slow and laborious process of gathering the waste data also causes the manufacturer to unnecessarily suffer increased raw materials costs, increased handling costs, and increased waste treatment and disposal costs.

There is, accordingly, a need in the art for methods and systems of inexpensively monitoring waste streams, for methods and systems of inexpensively predicting waste production, for methods and systems of quickly reducing the production of wastes, for methods and systems of quickly gathering, formatting, and reporting waste data to regulatory agencies, and for methods and systems that facilitate monitoring and sharing waste data.

### SUMMARY OF INVENTION

Methods and systems are disclosed for reducing wastes produced from an industrial process. These methods and systems utilize e-commerce to reduce the costs and the liabilities associated with wastes generated from industrial processes. An integrated six (6) sigma system is discussed that is capable of measuring, analyzing, improving, and controlling process parameters to reduce wastes. These methods and systems utilize communications networks to enhance the transfer of waste data, and other pollution prevention data, between plant sites or between customers.

One embodiment describes communicating with a communications network and acquiring process information concerning the industrial process. A process parameter, associated with a predicted waste output, is predicted according to a predetermined model and based on the process information. The process parameter is then communicated over the communications network.

Another embodiment describes a method of displaying industrial waste information from an industrial process. Here process information, concerning the industrial process, is acquired. The process information is acquired from a globally distributed computing network. The process information comprises at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, vi) flow rate of the effluent discharged from the industrial process, vii) amount of a chemical species used by the industrial process, viii) amount of a pollutant produced by the industrial process, and ix) amount of an effluent discharged from the industrial process. A process parameter is then acquired that may reduce waste from the industrial process. An image is displayed comprising at least one of the process information and the process parameter.

A central processing center is also disclosed. The central processing center is for reducing wastes produced by an industrial process. The central processing center includes a Waste Reduction module and a processor. The Waste Reduction module acquires at least one of pollutant information and effluent information communicated along a globally distributed computing network. The pollutant information is associated with pollutants produced by the industrial process, and the effluent information is associated with effluents discharged by the industrial process. The Waste Reduction module predicts, or estimates, process parameters that may reduce wastes produced by the industrial process. The processor is capable of predicting, or of estimating, the process parameters that may reduce wastes produced by the industrial process.

A further embodiment describes a waste management system. The waste management system has at least one of i) a source producing a pollutant and ii) a source discharging an effluent. The waste management system has at least one of i) a pollutant monitor for monitoring the pollutant produced by the source and ii) an effluent monitor for monitoring the effluent discharged by the source. The pollutant monitor produces pollutant information and the effluent monitor produces effluent information. A Waste Reduction module acquires at least one of the pollutant information and the effluent information communicated along a communications network. The Waste Reduction module predicts, or estimates, process parameters that may reduce wastes produced by the industrial process.

Still another embodiment describes a system configured for reducing wastes from an industrial process. The system includes a Waste Reduction module and a processor. The Waste Reduction module acquires at least one of pollutant information and effluent information communicated along a globally distributed computing network. The pollutant information is associated with pollutants produced by the industrial process, and the effluent information is associated with effluents discharged by the industrial process. The processor is capable of manipulating the acquired information and of predicting, or of estimating, process parameters that may reduce wastes produced by the industrial process.

A computer program product is also disclosed. The computer program product helps reduce wastes from an industrial process. The computer program product includes a memory storage device and a Waste Reduction module stored on the memory storage device. The Waste Reduction module acquires at least one of pollutant information and effluent information communicated along a globally distributed computing network. The pollutant information is associated with pollutants produced by the industrial process, and the effluent information is associated with effluents discharged by the industrial process. The Waste Reduction module predicts, or estimates, process parameters that may reduce wastes produced by the industrial process.

### BRIEF DESCRIPTION OF DRAWINGS

FIG. 1 is a block diagram showing the Waste Reduction module residing in a computer system;

FIG. 2 is a block diagram of a communications network further representing an operating environment for the Waste Reduction module;

FIG. 3 is a schematic drawing of one embodiment of the Waste Reduction module;

FIG. 4 is a schematic drawing of another embodiment of the Waste Reduction module;

FIG. 5 is a schematic drawing of still another embodiment of the Waste Reduction module;

FIG. 6 is a schematic drawing of yet another embodiment of the Waste Reduction module;

FIG. 7 is a schematic drawing of another embodiment of the Waste Reduction module; and

FIG. 8 is a flowchart describing a method of displaying industrial waste information from an industrial process.

### DETAILED DESCRIPTION

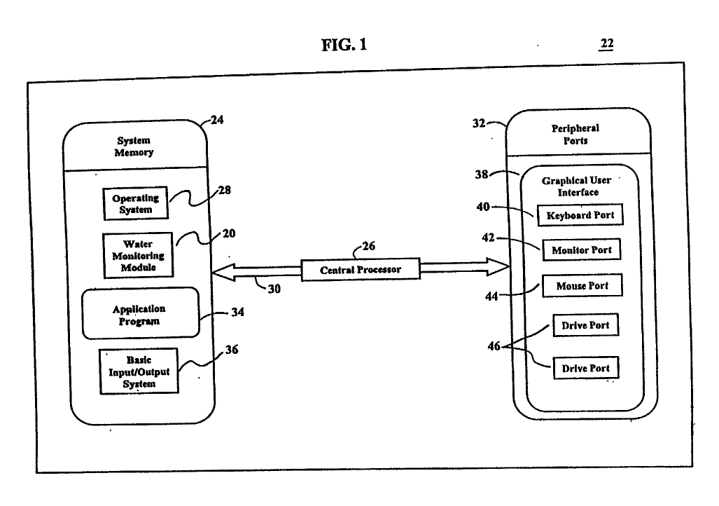

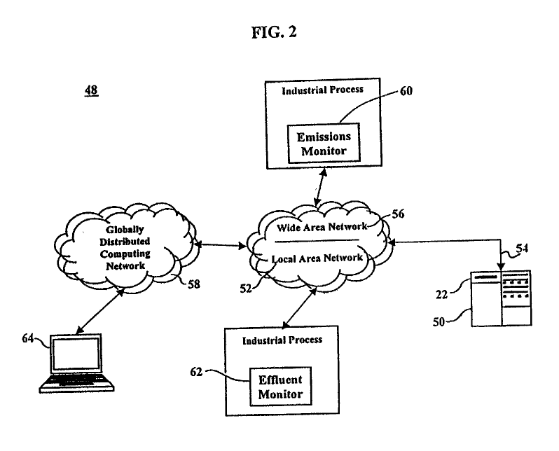

FIGS. 1 and 2 depict a possible computer operating environment for an embodiment of the present invention. This embodiment of a Waste Reduction module 20 comprises a computer program that acquires information and that predicts process parameters that may help reduce wastes from an industrial process. As those of ordinary skill in the art of computer programming recognize, computer programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art.

FIG. 1 is a block diagram showing the Waste Reduction module 20 residing in a computer system 22. The Waste Reduction module 20 may be stored within a system memory device 24. The computer system 22 also has a central processor 26 executing an operating system 28. The operating system 28 also resides within the system memory device 24. The operating system 28 has a set of instructions that control the internal functions of the computer system 22. A system bus 30 communicates signals, such as data signals, control signals, and address signals, between the central processor 26, the system memory device 24, and at least one peripheral port 32. Those of ordinary in the art understand that the program, processes, methods, and systems described in this patent are not limited to any particular computer system or computer hardware.

Those of ordinary skill in art also understand the central processor 26 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). While only one microprocessor is shown, those of ordinary skill in the art also recognize multiple processors may be utilized. Those of ordinary skill in the art further understand that the program, processes, methods, and systems described in this patent are not limited to any particular manufacturer's central processor.

The system memory 24 also contains an application program 34 and a Basic Input/Output System (BIOS) program 36. The application program 34 cooperates with the operating system 28 and with the at least one peripheral port 32 to provide a Graphical User Interface (GUI) 38. The Graphical User Interface 38 is typically a combination of signals communicated along a keyboard port 40, a monitor port 42, a mouse port 44, and one or more drive ports 46. The Basic Input/Output System 36, as is well known in the art, interprets requests from the operating system 28. The Basic Input/Output System 36 then interfaces with the keyboard port 40, the monitor port 42, the mouse port 44, and the drive ports 46 to execute the request.

The operating system 28 is WINDOWS® (WINDOWS® is a registered trademark of Microsoft Corporation, One Microsoft Way, Redmond Wash. 98052-6399, 425.882.8080, www.Microsoft.com). WINDOWS® is typically preinstalled in the system memory device 24. Those of ordinary skill in the art also recognize many other operating systems are suitable, such as UNIX® (UNIX® is a registered trademark of the Open Source Group, www.opensource.org), Linux, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

FIG. 2 is a block diagram of a communications network 48. This communications network 48 further represents an operating environment for the Waste Reduction module (shown as reference numeral 20 in FIG. 1). The Waste Reduction module resides within the memory storage device (shown as reference numeral 24 in FIG. 1) in the computer system 22. The computer system 22 is shown as a server 50. The server 50 may communicate with a Local Area Network (LAN) 52 along one or more data communication lines 54 or via wireless interfaces. As those of ordinary skill have long understood, the Local Area Network 52 is a grid of communication lines through which information is shared between multiple nodes. These multiple nodes are conventionally described as network computers or network peripherals. As those of ordinary skill in the art also recognize, server 50 could also communicate with a Wide Area Network (WAN) 56 and with a globally-distributed computing network 58 (e.g., the “Internet”). The communications network 48 allows the server 50 to request and to acquire information from many other computers and peripherals connected to the Local Area Network 52, the Wide Area Network 56, and the globally-distributed computing network 58.

As FIG. 2 shows, the server 50 may request and acquire information from many peripherals and many computers connected to the communications network 48. The server 50, for example, may acquire information from an emissions monitor 60. The emissions monitor 60, for example, may monitor pollutant emissions emitted from an industrial process. Such emissions may include, but are not limited to, nitrogen oxides (NO_{X}), carbon monoxide (CO), carbon dioxide (CO₂), methane (CH₄), nitrous oxide (N₂O), sulfur dioxide (SO₂), volatile organic compounds, and particulate matter. The server 50 could also acquire information from effluent monitor 62. The effluent monitor 62 monitors effluent streams of air, water, and solids discharged from the industrial process. FIG. 2 also shows that remote users, such as environmental engineers, Environmental Protection Agency regulators, and plant operators, may use a remote computer 64 to access the communications network 48 and to remotely access the server 50. Because many computers and peripherals may interface with the communications network 48, peripherals, computers, and computer users may share and communicate a vast amount of information acquired and processed by the Waste Reduction module. The Waste Reduction module acquires this information and uses this information to predict process parameters that may reduce waste from the industrial process.

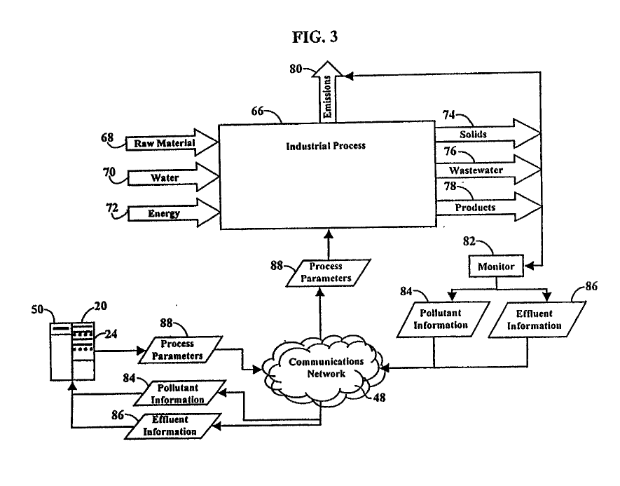

FIG. 3 is a schematic drawing of one embodiment of the present invention. The Waste Reduction module 20, as before, resides within the memory storage device 24 of the server 50. An industrial process, simply shown as block 66, generically represents all industrial processes. As those of ordinary skill recognize, the industrial process 66 consumes one or more inputs, such as raw materials 68, water 70, and energy 72, and produces wastes, such as solids 74, wastewater 76, products 78, and emissions 80. At least one monitor 82 measures the wastes and produces pollutant information 84 and effluent information 86. The pollutant information 84 is associated with pollutants produced by the industrial process 66. The effluent information 86 is associated with effluents discharged by the industrial process 66. The pollutant information 84 and the effluent information 86 are communicated along the communications network 48 to the Waste Reduction module 20 residing within the server 50. The Waste Reduction module 20 acquires the pollutant information 84 and/or the effluent information 86. The Waste Reduction module 20 then models the industrial process 66 using the pollutant information 84 and the effluent information 86. The Waste Reduction module 20 predicts or estimates one or more process parameters 88 that may reduce wastes produced by the industrial process 66. The process parameters 88 are communicated along the communications network 48 to the industrial process 66. Plant personnel, or computer-controlled equipment, may then receive the process parameters 88 and alter the industrial process 66 to help reduce waste. The use of the communications network 48, therefore, reduces the costs and the liabilities associated with wastes produced by the industrial process 66 and, thereby, enhances process efficiencies.

The pollutant information 84 and the effluent information 86 may represent many indications of wastes produced by the industrial process 66. The pollutant information 84 and the effluent information 86 could represent industrial process information such concentration of a chemical species used by the industrial process, concentration of a pollutant produced by the industrial process, concentration of an effluent discharged from the industrial process, flow rate of the chemical species used by the industrial process, flow rate of the pollutant produced by the industrial process, flow rate of the effluent discharged from the industrial process, amount of a chemical species used by the industrial process, amount of a pollutant produced by the industrial process, and amount of an effluent discharged from the industrial process. As those of ordinary skill in the art recognize, sometimes the concentration of a pollutant or effluent is difficult to determine. The concentration of a solid in a feed or waste stream, for example, metals and scrap metals, is difficult to determine. Measuring the amount of pollutant or effluent is instead preferred. The pollutant information 84 and the effluent information 86 could include information concerning an effluent stream of air, an effluent stream of water, and/or an effluent stream of a solid. The pollutant information 84 and the effluent information 86 would include inorganic materials, acids, heavy metals, and inorganic species used by the industrial process and/or discharged from the industrial process. A species of acid, for example, could include information concerning at least one of hydrochloric acid (HCl), nitric acid (HNO₃), perchloric acid (HClO₄), sulfuric acid (H₂SO₄), phosphoric acid (H₃PO₄), acetic acid (HC₂H₃O₂), hydrogen fluoride (HF), carbonic acid (H₂CO₃), and any other chemical compound that ionizes in water to provide a hydrogen ion H⁺. A heavy metal species could include information concerning at least one of lead (Pb), mercury (Hg), chromium (Cr), copper (Cu), and cadmium (Cd). The organic species could include information concerning at least one of an alkane, an alcohol, an ether, an alkene, an alkyne, an aromatic compound, an alkyl halide, an ester, a carboxylic acid, a carbonyl compound, an aldehyde/ketone (e.g., formaldehyde, acetone, methyl ethyl ketone, diethyl ketone), an amine, and an amide. The organic species could include benzene (C₆H₆), toluene (C₆H₅CH₃), xylene[C₆H₄(CH₃)₂], naphthalene (C₁₀H₈), dichloromethane (CH₂Cl₂), trichloromethane (CHCl₃), styrene, ethylene, phenol, methylene chloride, xylene, and methyl ethyl ketone. The pollutant information 84 and the effluent information 86 could include information concerning air pollutant emissions produced by the industrial process, information concerning a volatile organic compound produced by the industrial process, and information concerning an ozone depleting compound produced by the industrial process.

The at least one monitor 82 measures the wastes and produces the pollutant information 84 and the effluent information 86. The term “monitor” includes meters, sensors, and other measuring/metering/sensing devices that acquire, or that indicate, the amount of wastes produced by the industrial process 66. The term “monitor,” however, also includes any analog-to-digital conversion devices, data acquisition devices, or other electrical/computer enhancements that enable the at least one monitor 82 to acquire and to share the pollutant information 84 and the effluent information 86 along the communications network 48. See, e.g., The American Heritage Dictionary 810 (1991).

The Waste Reduction module 20 then arranges modeling of the industrial process 66. The Waste Reduction module 20 interfaces with various process analysis models and/or process simulation models. These various models determine the process parameters 88 that could reduce, or minimize, the wastes produced by the industrial process. The models, in general, predict the amount of solids 74, wastewater 76, products 78, and emissions 80 produced as one or more of the process parameters 88 are changed. Although these process analysis models and/or process simulation models can be specially-designed for unique or for proprietary industrial processes, several models are commercially available. The Hydromantis GPS-X computer product is one example of wastewater treatment process modeling and simulation technology (Hydromantis, Inc., Suite 302, 1685 Main Street West, Hamilton, Ontario, Canada L8S 1G5, Tel: (905) 522-0012, www.hydromantis.com

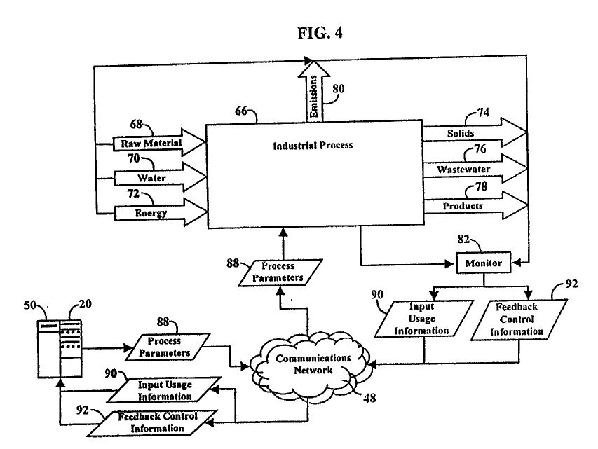

FIG. 4 is a schematic drawing of another embodiment of the present invention. Here the Waste Reduction module 20 also receives information concerning the inputs to the industrial process 66 and information concerning operating variables for the industrial process 66. The at least one monitor 82, for example, monitors the usage of the raw materials 68, the water 70, and the energy 72 inputs and generates input usage information 90. The at least one monitor 82 could also monitor the industrial process 66 itself by receiving feedback control information 92, such as machine settings, process operating variables, and control data for the industrial process 66. The input usage information 90 and the feedback control information 92 are communicated along the communications network 48 to the Waste Reduction module 20 residing within the server 50. The Waste Reduction module 20 acquires the input usage information 90 and the feedback control information 92, models the industrial process 66, and then communicates the updated process parameters 88 along the communications network 48 to the industrial process 66. Plant personnel, or computer-controlled equipment, may then receive the process parameters 88 and alter the industrial process 66 to help reduce waste.

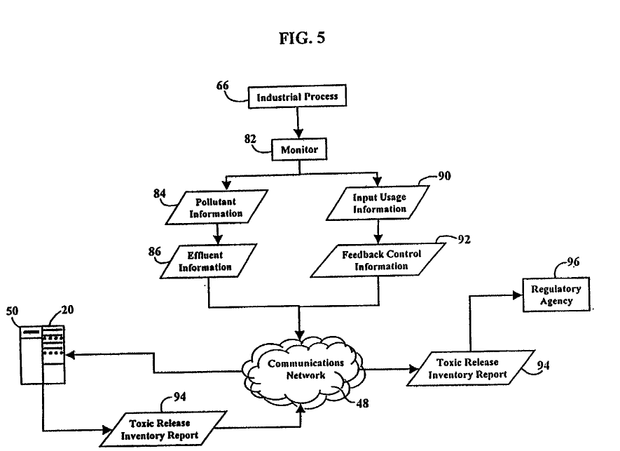

FIG. 5 is a schematic drawing of still another embodiment of the Waste Reduction module 20. FIG. 5 shows the Waste Reduction module 20 could report waste releases and transfers to governmental regulatory agencies. The Waste Reduction module 20 acquires the pollutant information 84, the effluent information 86, the input usage information 90, and the feedback control information 92. The Waste Reduction module 20 could then format the acquired information to the reporting requirements of a state or federal agency. The Waste Reduction module 20, for example, could create a toxic release inventory report 94. The toxic release inventory report 94 could be communicated along the communications network 48 to a regulatory agency 96. The Waste Reduction module 20 may thus reduce, or even eliminate, the need for plant personnel to monitor and to report waste releases.

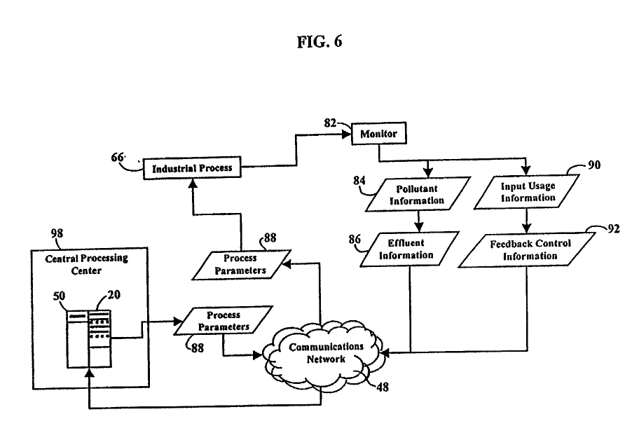

FIG. 6 is a schematic drawing of still another embodiment of the present invention. Here the pollutant information 84, the effluent information 86, the input usage information 90, and the feedback control information 92 are communicated along the communications network 48 to a central processing center 98. The central processing center 98 would include the server 50 running the Waste Reduction module 20. The Waste Reduction module 20 acquires any of the pollutant information 84, the effluent information 86, the input usage information 90, and the feedback control information 92. The Waste Reduction module 20 models the industrial process 66 and predicts the process parameters 88 that may reduce wastes. The process parameters 88, as before, are communicated along the communications network 48 to the industrial process 66. The central processing center 98 serves as a remote analysis center for the industrial process 66. Because the process analysis models and/or process simulation models are often quite complex, local plant personnel may not have the expertise or the resources to analyze waste data. The central processing center 98 would be staffed to analyze waste data, to predict the process parameters 88, and to generate regulatory reports. The central processing center 98 could also serve as a central document storage facility to store waste data and regulatory reports for subsequent retrieval.

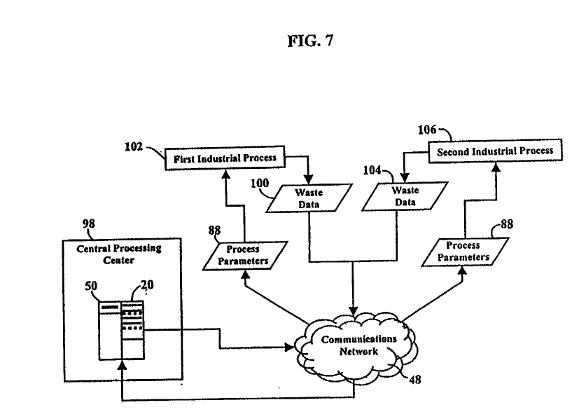

FIG. 7 is a schematic drawing of yet another embodiment of the present invention. As FIG. 6 suggests, the central processing center 98 could serve more than one industrial process or site. The central processing center 98, including the server 50 running the Waste Reduction module 20, could receive waste data from many different plants or processes. The central processing center 98 could then serve as a single waste reduction facility for an entire corporation. The central processing center 98 could also offer waste reduction services on a contractual relationship with process/plant customers. As FIG. 7 shows, the Waste Reduction module 20 could receive waste data 100 from a first industrial process The waste data 100 could include any of the pollutant information, the effluent information, the input usage information, and the feedback control information (shown respectively as reference numerals 82, 84, 90, and 92 in FIG. 5). The Waste Reduction module 20 models the first industrial process 102, predicts the process parameters 88 that may reduce wastes, and sends the process parameters 88 along the communications network 48 to the first industrial process 102. The Waste Reduction module 20, likewise, could receive waste data 104 from a second industrial process 106, predict the process parameters 88, and send the process parameters 88 along the communications network 48 to the second industrial process 106. Although only the first industrial process 102 and the second industrial process 106 are shown, those of ordinary skill in the art now understand that the central processing center 98 could serve as many industrial facilities as resources and computing infrastructure permit.

Because the central processing center 98 could serve many industrial processes, the Waste Reduction module 20 should coordinate modeling. If multiple industrial processes are served, each industrial process would likely have its own unique model and/or modeling parameters. The central processing center 98 would then also maintain a database of models and model parameters, and the Waste Reduction module 20 would access the database for the correct model(s) corresponding to the industrial process. The central processing center 98 could also maintain one or more databases for storing process inputs, waste data, operating parameters, and regulatory emissions reports.

The Waste Reduction module 20 could also be advantageous for emissions trading programs. As the Environmental Protection Agency allows, affected sources of pollutant emissions can buy and sell emission allowances on the open market. See Clean Air Act (Title IV, Acid Rain Program) §401, 42 U.S.C.A. §7651(b) (West 1995 & Supp. 2000). Participants in this market-based system for buying and selling emissions allowances can use the Waste Reduction module 20 to track, monitor, and report waste emissions. Participants could also use the Waste Reduction module 20 to verify the allowances offered by other participants. Participants could access website, via the communications network 48, and view emissions trading allowances offered by other participants. The Waste Reduction module 20 thus provides a single, on-line source for verifying, buying, and selling emissions allowances.

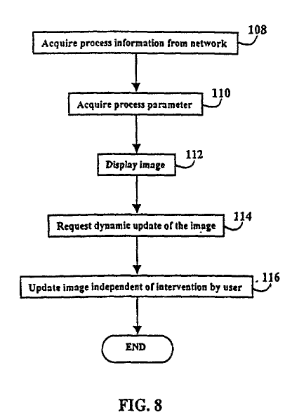

FIG. 8 is a flowchart describing a method of displaying industrial waste information from an industrial process. Process information is acquired from a globally distributed computing network (Block 108). The process information could comprise at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, and vi) flow rate of the effluent discharged from the industrial process. A process parameter is also acquired (Block 110). An image is displayed (Block 112). The image comprises at least one of the process information and the process parameter. A computer user may request a dynamic update of the image (Block 114), or the image may be updated independent of intervention by a user (Block 116).

The Waste Reduction module 20 may be physically embodied on or in a computer-readable medium. This computer-readable medium may be CD-ROM, DVD, tape, cassette, floppy disk, memory card, and a large-capacity disk (such as IOMEGA® ZIP®, JAZZ®, and other large-capacity memory products) (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer readable media, and other types not mentioned here but considered within the scope of the present invention, allow the Waste Reduction module 20 to be easily disseminated. A computer program product for reducing wastes from an industrial process includes the Waste Reduction module 20 stored on a memory storage device. The Waste Reduction module 20 acquires at least one of pollutant information and effluent information communicated along a globally distributed computing network. The pollutant information is associated with pollutants produced by the industrial process, and the effluent information is associated with effluents discharged by the industrial process. The Waste Reduction module 20 models the industrial process and predicts process parameters that may reduce wastes produced by the industrial process.

While the present invention has been described with respect to various features, aspects, and embodiments, those of ordinary skill in the art, and those unskilled, will recognize the invention is not so limited. Other variations, modifications, and alternative embodiments may be made without departing from the spirit and scope of the present invention.

1. A method of reducing wastes produced from an industrial process, comprising:
communicating with a communications network and acquiring process information concerning the industrial process;
predicting a process parameter associated with a predicted waste output according to a predetermined model and based on the process information; and
communicating the process parameter over the communications network.

2. A method of reducing wastes according to claim 1, wherein the step of communicating with a communications network comprises communicating with a globally distributed computing network.

3. A method of reducing wastes according to claim 1, wherein the step of communicating with a communications network comprises communicating with at least one of a local area network, a wide area network, and a globally distributed computing network.

4. A method of reducing wastes according to claim 1, wherein the step of acquiring process information comprises acquiring at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, and vi) flow rate of the effluent discharged from the industrial process.

5. A method of reducing wastes according to claim 1, wherein the step of acquiring process information concerning the industrial process comprises acquiring information concerning at least one of an effluent stream of air, an effluent stream of water, and an effluent stream of a solid.

6. A method of reducing wastes according to claim 1, wherein the step of acquiring process information comprises acquiring information concerning at least one of i) inorganic materials used by the industrial process and ii) inorganic materials discharged from the industrial process.

7. A method of reducing wastes according to claim 1, wherein the step of acquiring process information comprises acquiring information concerning at least one of i) a species of acid used by the industrial process and ii) a species of acid discharged from the industrial process.

8. A method of reducing wastes according to claim 7, further comprising acquiring information concerning a chemical compound that ionizes in water to provide a hydrogen ion H⁺.

9. A method of reducing wastes according to claim 7, further comprising acquiring information concerning at least one of hydrochloric acid (HCl), nitric acid (HNO₃), perchloric acid (HClO₄), sulfuric acid (H₂SO₄), phosphoric acid (H₃PO₄), acetic acid (HC₂H₃O₂), hydrogen fluoride (HF), and carbonic acid (H₂CO₃).

10. A method of reducing wastes according to claim 1, wherein the step of acquiring process information comprises acquiring information concerning at least one of i) a heavy metal species used by the industrial process and ii) a heavy metal species discharged from the industrial process.

11. A method of reducing wastes according to claim 10, further comprising acquiring information concerning at least one of lead (Pb), mercury (Hg), chromium (Cr), copper (Cu), and cadmium (Cd).

12. A method of reducing wastes according to claim 1, wherein the step of acquiring process information comprises acquiring information concerning at least one of i) an organic species used by the industrial process and ii) an organic species discharged from the industrial process.

13. A method of reducing wastes according to claim 12, further comprising acquiring information concerning at least one of an alkane, an alcohol, an ether, an alkene, an alkyne, an aromatic compound, an alkyl halide, an ester, a carboxylic acid, a carbonyl compound, an aldehyde, and a ketone, an amine, and an amide.

14. A method of reducing wastes according to claim 12, further comprising acquiring information concerning at least one of benzene (C₆H₆), toluene (C₆H₅CH₃), xylene[C₆H₄(CH₃)₂], naphthalene (C₁₀H₈), dichloromethane (CH₂Cl₂), trichloromethane (CHCl₃), styrene, ethylene, phenol, methylene chloride, xylene, and methyl ethyl ketone.

15. A method of reducing wastes according to claim 1, further comprising acquiring information concerning air pollutant emissions produced by the industrial process.

16. A method of reducing wastes according to claim 1, further comprising acquiring information concerning a volatile organic compound produced by the industrial process.

17. A method of reducing wastes according to claim 1, further comprising acquiring information concerning an ozone depleting compound produced by the industrial process.

18. A method of reducing wastes according to claim 1, further comprising forecasting wastes produced by the industrial process, the forecasted wastes based upon the process information.

19. A method of reducing wastes according to claim 1, further comprising simulating the industrial process with a computer program that determines the process parameters.

20. A method of reducing wastes according to claim 1, further comprising forecasting costs of operating the industrial process at the process parameter.

21. A method of reducing wastes according to claim 1, further comprising estimating costs of operating the industrial process at the process parameter.

22. A method of reducing wastes according to claim 1, further comprising communicating information concerning waste emissions over the communications network to a regulatory agency.

23. A method of reducing wastes according to claim 1, further comprising communicating information concerning waste emissions over the communications network to participants in a system for buying and selling emissions allowances.

24. A method of reducing wastes produced from an industrial process, comprising:
communicating with a globally distributed computing network and acquiring process information concerning the industrial process, the process information comprising at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, and vi) flow rate of the effluent discharged from the industrial process;
predicting a process parameter associated with a predicted waste output according to a predetermined model and based on the process information; and
communicating the process parameter over the globally distributed computing network.

25. A method of displaying industrial waste information from an industrial process, the method comprising:
acquiring process information concerning the industrial process, the process information acquired from a globally distributed computing network, the process information comprising at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, and vi) flow rate of the effluent discharged from the industrial process;
acquiring a process parameter that may reduce waste from the industrial process; and
displaying an image comprising at least one of the process information and the process parameter.

26. A method of displaying industrial waste information according to claim 25, further comprising dynamically updating said image.

27. A method of displaying industrial waste information according to claim 25, further comprising dynamically updating said image independent of intervention by a user.

28. A method of displaying industrial waste information according to claim 25, further comprising requesting a dynamic update of said image.

29. A waste management system, comprising:
at least one of i) a source producing a pollutant and ii) a source discharging an effluent;
at least one of i) a pollutant monitor for monitoring the pollutant produced by the source and ii) an effluent monitor for monitoring the effluent discharged by the source, the pollutant monitor producing pollutant information and the effluent monitor producing effluent information; and
a Waste Reduction module acquiring at least one of the pollutant information and the effluent information communicated along a communications network, the Waste Reduction module predicting process parameters that may reduce wastes produced by the industrial process.

30. A waste management system according to claim 29, wherein the communications network comprises at least one of a local area network and a wide area network.

31. A waste management system according to claim 29, wherein at least one of the pollutant monitor and the effluent monitor monitors at least one of i) inorganic materials used by the industrial process and ii) inorganic materials discharged from the industrial process.

32. A waste management system according to claim 29, wherein at least one of the pollutant monitor and the effluent monitor monitors at least one of i) a species of acid used by the industrial process and ii) a species of acid discharged from the industrial process.

33. A waste management system according to claim 32, wherein the species of acid comprises a chemical compound that ionizes in water to provide a hydrogen ion H⁺.

34. A waste management system according to claim 29, wherein at least one of the pollutant monitor and the effluent monitor monitors at least one of hydrochloric acid (HCl), nitric acid (HNO₃), perchloric acid (HClO₄), sulfuric acid (H₂SO₄), phosphoric acid (H₃PO₄), acetic acid (HC₂H₃O₂), hydrogen fluoride (HF), and carbonic acid (H₂CO₃).

35. A waste management system according to claim 29, wherein at least one of the pollutant monitor and the effluent monitor monitors at least one of i) a heavy metal species used by the industrial process and ii) a heavy metal species discharged from the industrial process.

36. A waste management system according to claim 35, wherein the heavy metal species comprises at least one of lead (Pb), mercury (Hg), chromium (Cr), copper (Cu), and cadmium (Cd).

37. A waste management system according to claim 29, wherein at least one of the pollutant monitor and the effluent monitor monitors at least one of i) an organic species used by the industrial process and ii) an organic species discharged from the industrial process.

38. A waste management system according to claim 37, wherein the organic species comprises at least one of an alkane, an alcohol, an ether, an alkene, an alkyne, an aromatic compound, an alkyl halide, an ester, a carboxylic acid, a carbonyl compound, an aldehyde, and a ketone, an amine, and an amide.

39. A waste management system according to claim 37, wherein the organic species comprises at least one of benzene (C₆H₆), toluene (C₆H₅CH₃), xylene[C₆H₄(CH₃)₂], naphthalene (C₁₀H₈), dichloromethane (CH₂Cl₂), trichloromethane (CHCl₃), styrene, ethylene, phenol, methylene chloride, xylene, and methyl ethyl ketone.

40. A waste management system according to claim 29, further comprising at least one computer system communicating with the communications network, the at least one computer system acquiring the process parameter from the globally distributed computing network.

41. A waste management system according to claim 29, further comprising a computer system communicating with the globally distributed computing network, the computer system receiving at least one of the pollutant information and the effluent information.

42. A system configured for reducing wastes from an industrial process, the system comprising:
a Waste Reduction module acquiring at least one of pollutant information and effluent information communicated along a globally distributed computing network, the pollutant information associated with pollutants produced by the industrial process, and the effluent information associated with effluents discharged by the industrial process; and
a processor capable of manipulating the acquired information and of predicting process parameters that may reduce wastes produced by the industrial process.

43. A computer program product for reducing wastes from an industrial process, the computer program product comprising:
a memory storage device; and
a Waste Reduction module stored on the memory storage device, the Waste Reduction module acquiring at least one of pollutant information and effluent information communicated along a communications network, the pollutant information associated with pollutants produced by the industrial process, and the effluent information associated with effluents discharged by the industrial process, the Waste Reduction module predicting process parameters that may reduce wastes produced by the industrial process.

44. A central processing center for reducing wastes produced by an industrial process, the central processing center comprising:
a Waste Reduction module acquiring at least one of pollutant information and effluent information communicated along a globally distributed computing network, the pollutant information associated with pollutants produced by the industrial process, and the effluent information associated with effluents discharged by the industrial process, the Waste Reduction module predicting process parameters that may reduce wastes produced by the industrial process; and
a processor capable of predicting the process parameters that may reduce wastes produced by the industrial process.

45. A computer program for reducing wastes produced from an industrial process, comprising the steps of:
communicating with a communications network and acquiring process information concerning the industrial process;
predicting a process parameter associated with a predicted waste output according to a predetermined model and based on the process information; and
communicating the process parameter over the communications network.

46. A computer program for reducing wastes according to claim 45, wherein the step of communicating with a communications network comprises communicating with a globally distributed computing network.

47. A computer program for reducing wastes according to claim 45, wherein the step of communicating with a communications network comprises communicating with at least one of a local area network, a wide area network, and a globally distributed computing network.

48. A computer program for reducing wastes according to claim 45, wherein the step of acquiring process information comprises acquiring at least one of i) concentration of a chemical species used by the industrial process, ii) concentration of a pollutant produced by the industrial process, iii) concentration of an effluent discharged from the industrial process, iv) flow rate of the chemical species used by the industrial process, v) flow rate of the pollutant produced by the industrial process, and vi) flow rate of the effluent discharged from the industrial process.

49. A computer program for reducing wastes according to claim 45, wherein the step of acquiring process information concerning the industrial process comprises acquiring information concerning at least one of an effluent stream of air, an effluent stream of water, and an effluent stream of a solid.

50. A computer program for reducing wastes according to claim 45, wherein the step of acquiring process information comprises acquiring information concerning at least one of i) inorganic materials used by the industrial process and ii) inorganic materials discharged from the industrial process.

51. A computer program for reducing wastes according to claim 45, wherein the step of acquiring process information comprises acquiring information concerning at least one of i) a species of acid used by the industrial process and ii) a species of acid discharged from the industrial process.

52. A computer program for reducing wastes according to claim 51, further comprising the step of acquiring information concerning a chemical compound that ionizes in water to provide a hydrogen ion H⁺.

53. A computer program for reducing wastes according to claim 51, further comprising the step of acquiring information concerning at least one of hydrochloric acid (HCl), nitric acid (HNO₃), perchloric acid (HClO₄), sulfuric acid (H₂SO₄), phosphoric acid (H₃PO₄), acetic acid (HC₂H₃O₂) hydrogen fluoride (HF), and carbonic acid (H₂CO₃).

54. A computer program for reducing wastes according to claim 45, wherein the step of acquiring process information comprises acquiring information concerning at least one of i) a heavy metal species used by the industrial process and ii) a heavy metal species discharged from the industrial process.

55. A computer program for reducing wastes according to claim 54, further comprising the step of acquiring information concerning at least one of lead (Pb), mercury (Hg), chromium (Cr), copper (Cu), and cadmium (Cd).

56. A method of reducing wastes according to claim 45, wherein the step of acquiring process information comprises acquiring information concerning at least one of i) an organic species used by the industrial process and ii) an organic species discharged from the industrial process.

57. A computer program for reducing wastes according to claim 56, further comprising the step of acquiring information concerning at least one of an alkane, an alcohol, an ether, an alkene, an alkyne, an aromatic compound, an alkyl halide, an ester, a carboxylic acid, a carbonyl compound, an aldehyde, and a ketone, an amine, and an amide.

58. A computer program for reducing wastes according to claim 56, further comprising the step of acquiring information concerning at least one of benzene (C₆H₆), toluene (C₆H₅CH₃), xylene[C₆H₄(CH₃)₂], naphthalene (C₁₀H₈), dichloromethane (CH₂Cl₂), trichloromethane (CHCl₃), styrene, ethylene, phenol, methylene chloride, xylene, and methyl ethyl ketone.

59. A computer program for reducing wastes according to claim 45, further comprising the step of acquiring information concerning air pollutant emissions produced by the industrial process.

60. A computer program for reducing wastes according to claim 45, further comprising the step of acquiring information concerning a volatile organic compound produced by the industrial process.

61. A computer program for reducing wastes according to claim 45, further comprising the step of acquiring information concerning an ozone depleting compound produced by the industrial process.

62. A computer program for reducing wastes according to claim 45, further comprising the step of forecasting wastes produced by the industrial process, the forecasted wastes based upon the process information.

63. A computer program for reducing wastes according to claim 45, further comprising the step of simulating the industrial process with a computer program that determines the process parameters.

64. A computer program for reducing wastes according to claim 45, further comprising the step of forecasting costs of operating the industrial process at the process parameter.

65. A computer program for reducing wastes according to claim 45, further comprising the step of estimating costs of operating the industrial process at the process parameter.

66. A computer program for reducing wastes according to claim 45, further comprising the step of communicating information concerning waste emissions over the communications network to a regulatory agency.

67. A computer program for reducing wastes according to claim 45, further comprising the step of communicating information concerning waste emissions over the communications network to participants in a system for buying and selling emissions allowances.
